(19) United States
(12) Patent Application Publication
(10) Pub. No.: US 2023/0291089 A1
(43) Pub. Date: Sep. 14, 2023

(54) RADOME STRUCTURE FOR VEHICLE-MOUNTED RADAR DEVICE AND METHOD FOR MANUFACTURING SAME

(71) Applicants: SANKEI GIKEN KOGYO CO., LTD., Tokyo (JP); I-PEX Inc., Kyoto (JP)

(72) Inventors: Hiroyuki Kobayashi, Tokyo (JP); Ryuho Ikemasu, Tokyo (JP); Shinpei Yamamoto, Tokyo (JP); Hisashi Hamachi, Shizuoka-shi (JP)

(73) Assignee: SANKEI GIKEN KOGYO CO., LTD., Tokyo (JP)

(21) Appl. No.: 18/019,507

(22) PCT Filed: Jul. 21, 2021
(86) PCT No.: PCT/JP2021/027427

§ 371 Date: Feb. 3, 2023

(30) Foreign Application Priority Data
Aug. 4, 2020 (JP) 2020-132370

(51) Int. Cl. H01Q 1/02; H01Q 1/42; H01Q 1/32; G01S 7/02

(52) U.S. Cl. CPC H01Q 1/02; G01S 7/027; H01Q 1/32; H01Q 1/42

(57) ABSTRACT

Disclosed is a radome structure for vehicle-mounted radar devices, in which a planar heating element 2 is laminated and fixed onto a substrate 1 of the radome, a local recess 3 is provided so as to protrude from the substrate 1, a connecting body 4 for electrically connecting an electrode of a heater wire 21 of the planar heating element 2 to a power supply line 5 to the planar heating element 2 is accommodated in the recess 3, and the recess 3 is filled with an insulating resin 6 so as to embed and seal the connecting body 4. It is possible to simplify a connection structure and a waterproof structure of a connecting portion for electrically connecting the heater wire and the power supply line of the radome, and reduce the manufacturing cost of the radome structure having a snow melting function.

### TECHNICAL FIELD

The present invention relates to a radome for vehicle-mounted radar devices provided on a front side of a vehicle-mounted radar device, and more particularly, to a radome structure for vehicle-mounted radar devices having a snow melting function and a method for manufacturing the same.

### BACKGROUND ART

Conventionally, as a radome for vehicle-mounted radar devices, a radome that exhibits a snow-melting function while ensuring required electromagnetic wave permeability is known. The radome having this snow-melting function is generally formed by attaching a planar heating element such as a resin film with heater wires wired to a substrate. As such a radome, PTLs 1 and 2 disclose a radome in which a planar heating element is attached to the rear side of a front substrate of an intermediate formation body composed of a transparent member, a decorative layer, and a front substrate, and a rear substrate is fixed by welding or insert molding to the rear side of the planar heating element of the intermediate formation body to which the planar heating element is attached.

In the radomes of PTLs 1 and 2, a waterproof connector connected to both electrodes of the heater wire wired to the planar heating element is exposed to the rear side of the rear substrate, a vehicle-side connector introduced from the vehicle side is coupled to the waterproof connector via a cable from the rear side, and electric power is supplied to the heater wire.

### CITATION LIST

### Patent Literature

PTL 1] Japanese Patent Application Publication No. 2018-66705
PTL 2] Japanese Patent Application Publication No. 2018-66706

### SUMMARY OF INVENTIONS

### Technical Problem

By the way, the radomes for vehicle-mounted radar devices of PTLs 1 and 2 have a structure in which the waterproof connector of the heater wire exposed to the rear side of the rear substrate is mechanically and electrically coupled to the vehicle-side connector to supply electric power. However, this structure alone is not sufficient to ensure the required waterproofness against washing the vehicle or in the rain. In other words, in order to actually install this structure in a vehicle and ensure the required waterproofness, it is necessary to use a waterproof connector with a waterproof structure for the heater wire-side connector and apply a waterproof treatment using another waterproof member to a coupling point between the heater wire-side connector and the vehicle-side connector.

However, when a waterproof connector with a waterproof structure is used for the heater wire side connector and a waterproof treatment is applied using another waterproof member to the coupling point between the heater wire-side connector and the vehicle-side connector, there is a problem that the cost required for the waterproof treatment for the radome increase and the manufacturing cost of the radome becomes high.

The present invention is proposed in view of the above problems, and an object thereof is to provide a radome structure for vehicle-mounted radar devices and a method for manufacturing the same, capable of simplifying a connection structure and a waterproof structure of a connecting portion for electrically connecting the heater wire and the power supply line of the radome, and reducing the manufacturing cost of the radome structure having a snow melting function.

### Solution to Problem

In a radome structure for vehicle-mounted radar devices of the present invention, a planar heating element is laminated and fixed onto a radome substrate, a local recess is provided by a member protruding from the radome substrate; a connecting body for electrically connecting an electrode of the planar heating element and a power supply line to the planar heating element is accommodated in the recess, and the recess is filled with an insulating resin so as to embed and seal the connecting body.

According to this configuration, it is possible to eliminate the need to use a waterproof connector with a waterproof structure for the heater wire-side connector and apply a waterproof treatment using another waterproof member to the coupling point between the heater wire-side connector and the vehicle-side connector. That is, it is possible to simplify a connection structure and a waterproof structure of a connecting portion for electrically connecting the heater wire and the power supply line of the radome, and reduce the manufacturing cost of the radome structure having a snow melting function.

In the radome structure for vehicle-mounted radar devices of the present invention, the planar heating element is laminated and fixed onto a back surface on an opposite side of a viewing side of the radome substrate, and the member of the recess is provided so as to protrude from the back surface of the radome substrate toward the opposite side of the viewing side, or is provided so as to protrude sideways from a side end surface of the radome substrate.

According to this configuration, it is possible to prevent the protrusion of the recess toward the viewing side where the appearance of the radome for vehicle-mounted radar devices is visually recognized and secure the aesthetic appearance of the radome for vehicle-mounted radar devices and improve the degree of freedom in designing the appearance of the radome for vehicle-mounted radar devices.

In the radome structure for vehicle-mounted radar devices of the present invention, the recess is arranged at a position outside an electromagnetic wave irradiation region of the radome substrate irradiated by a vehicle-mounted radar device.

According to this configuration, it is possible to prevent the recess of the radome, the connecting body accommodated in the recess, and the insulating resin filled in the recess from interfering with the transmission and reception of electromagnetic waves of the vehicle-mounted radar device and ensure transmission and reception of desired electromagnetic waves of the vehicle-mounted radar device.

A method for manufacturing a radome structure for vehicle-mounted radar devices of the present invention is a method for manufacturing the radome structure for vehicle-mounted radar devices of the present invention, including: a first step of accommodating a connecting body for electrically connecting an electrode of a planar heating element laminated and fixed onto a radome substrate and a power supply line to the planar heating element in a local recess provided by a member protruding from the radome substrate; and a second step of conveying the radome substrate with an open side of the recess accommodating the connecting body facing upward and filling the recess with an insulating resin while being conveyed in this state to embed and seal the connecting body.

According to this configuration, the radome substrate is conveyed with the open side of the recess accommodating the connecting body facing upward, and the insulating resin is filled into the recess that opens upward. Thus, leakage of the insulating resin in a fluid state can be prevented even when no special liquid leakage prevention treatment is performed. Furthermore, even after the insulating resin in a fluid state is injected into the recess, since the recess is kept open upward, it is possible to prevent leakage of the insulating resin in a fluid state and cure the insulating resin with the lapse of time due to conveyance. Therefore, a radome structure having both a waterproof structure and a snow-melting structure can be manufactured very efficiently, and the manufacturing cost of the radome structure can be further reduced because no special liquid leakage prevention treatment is required.

In the method for manufacturing the radome structure for vehicle-mounted radar devices of the present invention, the first step involves using an intermediate structure including a planar heating element, a power supply line to the planar heating element, and a connecting body for electrically connecting an electrode of the planar heating element and the power supply line to laminate and fix the planar heating element of the intermediate structure onto a radome substrate and accommodating the connecting body of the intermediate structure in the local recess provided by a member protruding from the radome substrate.

According to this configuration, the connecting body of the intermediate structure is accommodated in the recess of the radome substrate using the intermediate structure composed of the planar heating element, the power supply line, and the connecting body thereof. Thus, it is possible to eliminate the need for the work of electrically connecting the planar heating element and the connecting body in the narrow space in the recess and the work of electrically connecting the power supply line and the connecting body, simplifying the manufacturing process and further improving the efficiency. In addition, when the connection work is performed within the recess using solder or the like for the electrical connection between the planar heating element and the connecting body, or the electrical connection between the power supply line and the connecting body, there is a possibility that a synthetic resin forming the radome substrate or a synthetic resin forming the local recesses may melt. However, since the connecting body of the intermediate structure is accommodated in the recess of the radome substrate, it is possible to prevent the deformation and defects of the shape due to melting of the synthetic resin.

### Advantageous Effects of Invention

According to the radome structure for vehicle-mounted radar devices of the present invention, it is possible to simplify a connection structure and a waterproof structure of a connecting portion for electrically connecting the heater wire and the power supply line of the radome, and reduce the manufacturing cost of the radome structure having a snow melting function.

### BRIEF DESCRIPTION OF DRAWINGS

FIG. 1 is a perspective view of a radome structure for vehicle-mounted radar devices according to an embodiment of the present invention.

FIG. 2 is a rear view of the radome structure for vehicle-mounted radar devices according to the embodiment.

FIG. 3 is a schematic explanatory diagram of a vehicle-mounted radar structure to which the radome structure for vehicle-mounted radar devices of the embodiment is applied.

FIG. 4 is a partially enlarged view of the radome of FIG. 3.

FIGS. 5(a) to 5(d) are process explanatory diagrams for explaining the manufacturing process of the radome structure for vehicle-mounted radar devices according to the embodiment.

FIG. 6 is a partial side view of a radome structure for vehicle-mounted radar devices according to a modification of the present invention.

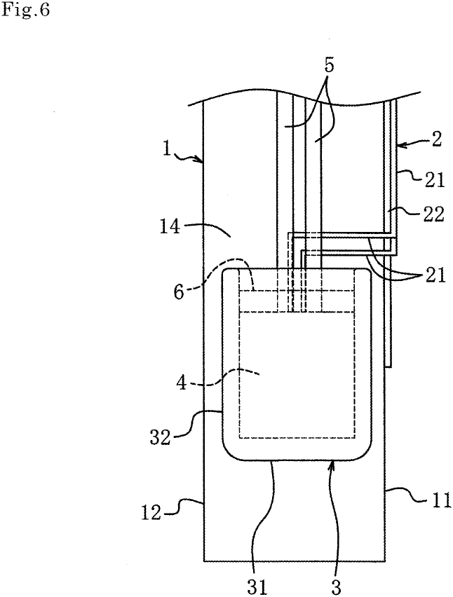

### DESCRIPTION OF EMBODIMENTS

### Radome Structure for Vehicle-Mounted Radar Devices And Manufacturing Method Thereof of Embodiment

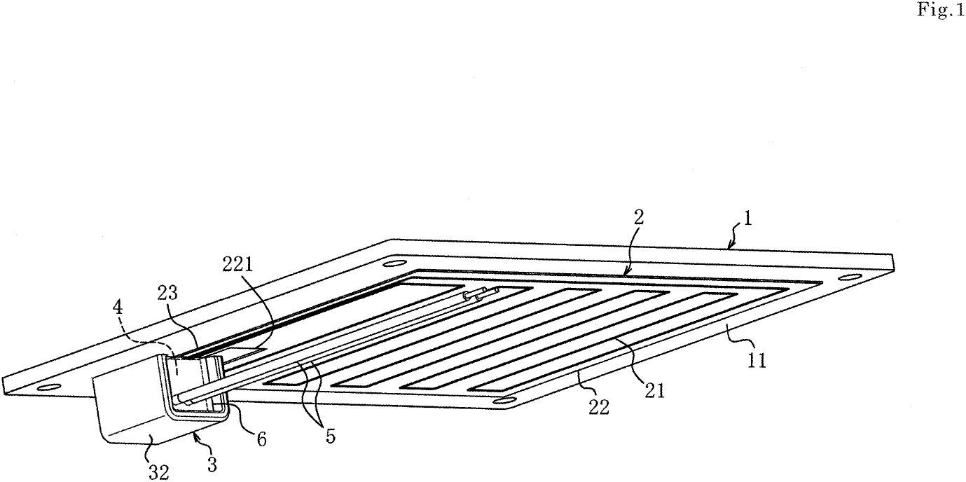

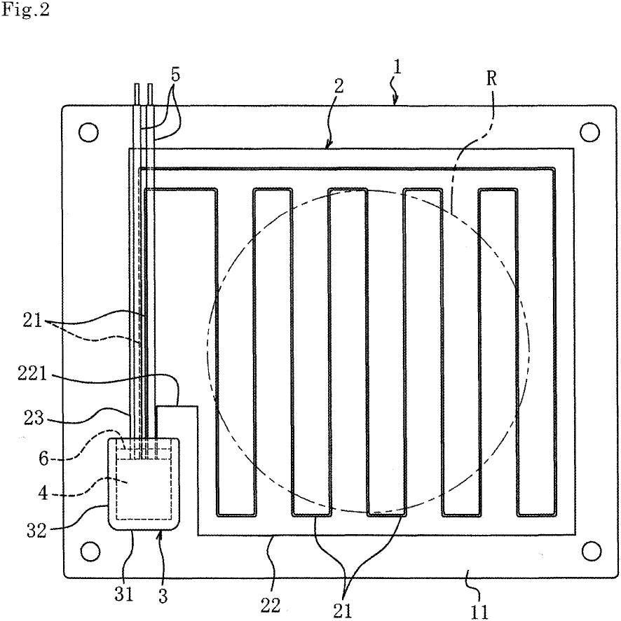

As shown in FIGS. 1 and 2, a radome structure for vehicle-mounted radar devices according to an embodiment of the present invention includes an electromagnetic wave permeable substrate 1 corresponding to a radome substrate. The substrate 1 can be made of any suitable material within the scope of the present invention, such as a synthetic resin, glass, or ceramics, and preferably, the substrate 1 is made of an insulating synthetic resin. When the substrate 1 is made of an insulating synthetic resin, the material is appropriately selected within an applicable range. For example, acrylonitrile-ethylene propyl rubber-styrene copolymer (AES), acrylic resin such as polymethyl methacrylate (PMMA), polycarbonate (PC), acrylonitrile-butadiene-styrene copolymer (ABS), acrylonitrile-styrene-acrylate copolymer (ASA), and polypropylene (PP) can be used alone or in combination of two or more, and the material may contain additives.

A planar heating element 2 is laminated and fixed onto the substrate 1, and in the present embodiment, the planar heating element 2 is laminated and fixed onto a back surface 11 on a side opposite to the viewing side of the substrate 1. Further, the planar heating element 2 in the present embodiment is configured so that a heater wire 21 is fixed to the back side of an insulating film 22, and the insulating film 22 is fixed to the back surface 11 of the substrate 1 by adhesion, welding, a double-sided tape, or the like. In the configuration in which the heater wire 21 is provided on the back side of the insulating film 22, the insulating film 22 ensures the insulation. For example, even when an electromagnetic wave permeable metal portion 711 is provided on a decorative layer 71 of an emblem radome, it is possible to suitably prevent the occurrence of conduction of the decorative layer 71. That is, regardless of the configuration of the decorative layer, it is possible to prevent the occurrence of conduction in the decorative layer due to the energization of the heater wire 21, and to reliably prevent the deterioration of the electromagnetic wave permeability due to the conduction of the decorative layer. If necessary, the heater wire 21 may be placed on the front side (the substrate 1 side) of the insulating film 22, or the heater wire 21 may be embedded in the insulating film 22.

The heater wire 21 is wired along the back surface 11 of the substrate 1 and is wired so as to extend over substantially the entire surface of the substrate 1 or over substantially the entire electromagnetic wave irradiation region of the substrate 1. Although the heater wire 21 in the illustrated example is wired in a meandering manner, other wiring manners such as wiring in concentric circles are also suitable. The heater wire 21 can be made of any applicable appropriate material such as nichrome wire, iron chromium, copper, silver, carbon fiber, or a transparent conductive film such as an ITO film. The insulating film 22 can be formed of any applicable appropriate material having insulating properties and electromagnetic wave permeability, and for example, an insulating synthetic resin such as polycarbonate (PC), polyethylene terephthalate (PET), polyethylene naphthalate (PEN), polyethylene (PE), polypropylene (PP), or polyimide (PI) is ideally used.

The substrate 1 is provided with a local recess 3 by a member protruding from the substrate 1, and in the present embodiment, the local recess 3 is provided by a member protruding from the back surface 11 on the side opposite to the viewing side of the substrate 1 toward the side opposite to the viewing side. In addition, the local recess 3 is arranged near the outer peripheral edge of the back surface 11 of the substrate 1 in order to expand the electromagnetic wave irradiation region that can ensure good electromagnetic wave permeability as much as possible. In the present embodiment, the recess 3 is arranged at a position outside the electromagnetic wave irradiation region R of the substrate 1 irradiated by a vehicle-mounted radar device 100. The recess 3 is formed in a pocket shape such that the bottom side is closed by a bottom portion 31, the recess 3 is surrounded by a peripheral wall 32 and the substrate 1, and the ceiling is open. The recess 3 or the member forming the recess 3 is preferably formed integrally with the substrate 1 and formed on the back surface 11 of the substrate 1. An intermediate member composed of the bottom portion 31 and the peripheral wall 32 may be preferably fixed to the back surface 11 of the substrate 1 by adhesion, caulking, or the like.

A connecting body 4 for electrically connecting an electrode of the planar heating element 2 and a power supply line 5 to the planar heating element 2 is accommodated in the recess 3. The heater wire 21 of the planar heating element 2 is introduced into the connecting body 4 of a connector in a state of being fixed to the insulating film 22 and is electrically connected to the connecting body 4 with both electrodes thereof being exposed at a position near the connecting body 4. The power supply line 5 that supplies electric power to the heater wire 21 is covered with a waterproof insulating coating such as a wire harness, and is introduced into the connecting body 4 of the connector, and a terminal exposed at a position near the connecting body 4 of the connector is electrically connected to the connecting body 4.

An insulating resin 6 is filled and cured in the recess 3, and the connecting body 4 is entirely embedded and sealed in the insulating resin 6. The connecting body 4, both electrodes of the exposed heater wire 21 electrically connected to the connecting body 4, and the exposed terminals of the power supply line 5 electrically connected to the connecting body 4 are all embedded and sealed in the insulating resin 6, and the waterproofness of the power supply line 5 and the heater wire 21 of the planar heating element 2 via the connecting body 4 is ensured.

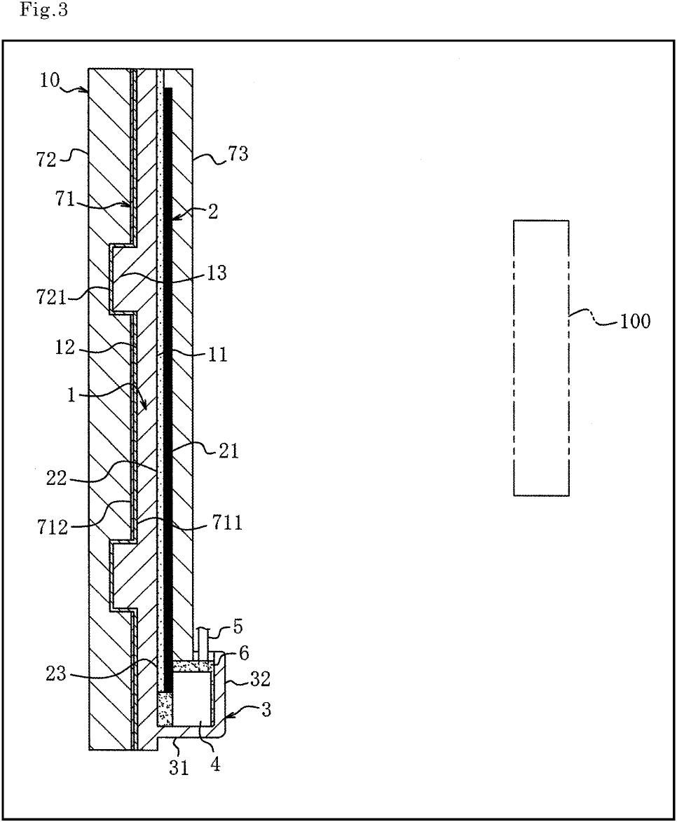

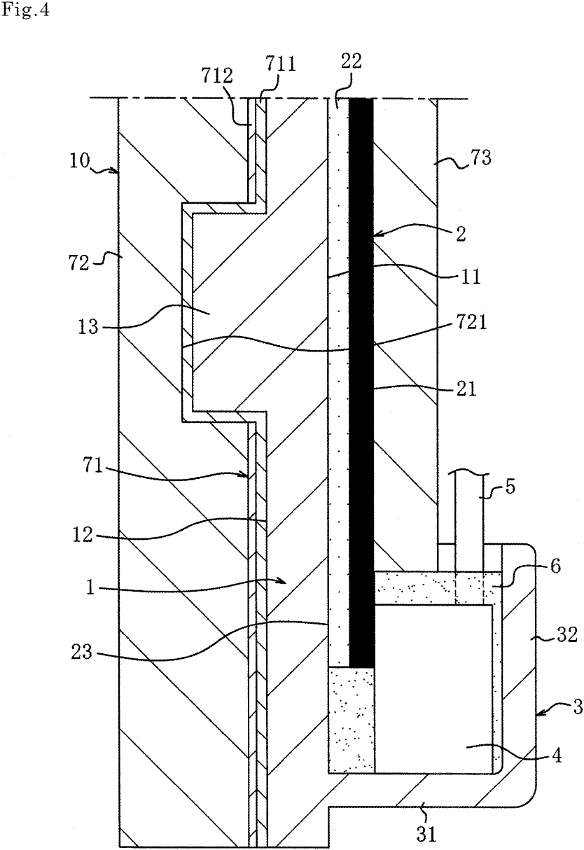

The radome structure for vehicle-mounted radar devices according to the present embodiment is suitable, for example, as an emblem such as a front grill mounted on a vehicle, a bumper, or the like. FIGS. 3 and 4 schematically show an example of a vehicle-mounted radar structure in which an emblem-shaped radome 10 is constructed using the radome structure for vehicle-mounted radar devices of the present embodiment, and the vehicle-mounted radar device 100 is arranged on the back side of this radome 10.

The radome 10 is arranged in front of the vehicle-mounted radar device 100 and attached to the vehicle, and is irradiated with electromagnetic waves such as millimeter waves from the vehicle-mounted radar device 100. Further, in the emblem-shaped radome 10 of this example, a decorative layer 71 and a transparent substrate 72 through which the decorative layer 71 can be visually recognized are laminated and fixed onto the front surface 12 of the substrate 1 corresponding to the radome substrate in that order toward the front. A rear substrate 73 is fixed to the back surface of the planar heating element 2 of the substrate 1 in a region avoiding the local recess 3.

The transparent substrate 72 and the rear substrate 73 have insulating properties and electromagnetic wave permeability, similarly to the substrate 1. The transparent substrate 72 and the rear substrate 73 are made of the same material as the substrate 1, for example. Specifically, from the viewpoint of improving the electromagnetic wave permeable performance, it is preferable to use materials of which the refractive indices n defined based on complex permittivity match each other or the refractive indices n are substantially the same or close to each other. As for the numerical range of the close refractive indices n of the transparent substrate 72 and the substrate 1, it is preferable that the difference between the refractive indices of the transparent substrate 72 and the substrate 1 is in the range of 0 to 10%. As for the numerical range of the close refractive indices n of the rear substrate 73 and the substrate 1, it is preferable that the difference between the refractive indices of the rear substrate 73 and the substrate 1 is in the range of 0 to 10%.

Here, the refractive index n is a quantity defined by Equation 1 from the real part of relative permittivity εr′ and the imaginary part of relative permittivity εr″. It is preferable from the viewpoint of permeability that the magnitude of the dielectric tangent (loss tangent) tanδ defined as Equation 2 from the ratio of the imaginary part and the real part at the application frequency is 0.1 or less. The magnitude of the real part of the relative permittivity is preferably 3 or less. By setting the magnitudes of the dielectric tangent and the real part of the relative permittivity to these values or less, it is possible to ensure a reduction in the reflectance and internal loss required for the redome.

$$n = \sqrt{\frac{{{ε}^{′}}_{r} + \sqrt{{{ε}^{′}}_{r}^{2} + {{ε}^{″}}_{r}^{2}}}{2}} \qquad \text{[Math. 1]}$$

$$t a n δ = \frac{{{ε}^{″}}_{r}}{{{ε}^{′}}_{r}} \qquad \text{[Math. 2]}$$

The decorative layer 71 of the present embodiment provided in close contact between the transparent substrate 72 and the substrate 1 is composed of an electromagnetic wave permeable metal portion 711 and a colored portion 712. Rather than forming the decorative layer 71 using the electromagnetic wave permeable metal portion 711 and the colored portion 712, for example, the decorative layer may be composed only of the electromagnetic wave permeable metal portion, or the decorative layer may be composed of only the colored portion.

The electromagnetic wave permeable metal portion 711 is composed of, for example, a discontinuous metal layer that has electromagnetic wave permeability and metallic luster, has brilliance and integral visibility, and is formed on the back surface of the transparent substrate 72 by electroless plating, vapor deposited, sputtering, or the like. When the electromagnetic wave permeable metal portion 711 is a discontinuous metal layer having brilliance and integral visibility, for example, it can be formed of nickel or nickel alloys, chromium or chromium alloys, cobalt or cobalt alloys, tin or tin alloys, copper or copper alloys, silver or silver alloys, palladium or palladium alloys, platinum or platinum alloys, rhodium or rhodium alloys, gold or gold alloys, or the like.

The colored portion 712 has electromagnetic wave permeability and is formed by printing, painting using a painting mask, or the like. In the illustrated example, the decorative layer 71 is provided in close contact with the back surface of the transparent substrate 72 so that the colored portion 712 is laminated on a portion on the surface side of the electromagnetic wave permeable metal portion 711. The electromagnetic wave permeable metal portion 711 is formed in a layer over the entire region where the back surface of the transparent substrate 72 is exposed and the entire region where the colored portion 712 is provided. The decorative layer 71 is provided in close contact with the colored portion 712 and the exposed back surface of the transparent substrate 72. A recess 721 is formed on the back side of the transparent substrate 72 at a position corresponding to the mark symbol part of the emblem, and the decorative layer 71 is formed in a curved shape so as to partially protrude toward the front side in a cross-sectional view so as to follow the recess 721. In the examples of FIGS. 3 and 4, a protrusion 13 is formed on the substrate 1 at a position corresponding to the recess 721 of the transparent substrate 72, and the protrusion 13 engages with the recess 721 and the decorative layer 71 in the recess 721 so that the substrate 1 is fixed to the decorative layer 71 and the transparent substrate 72.

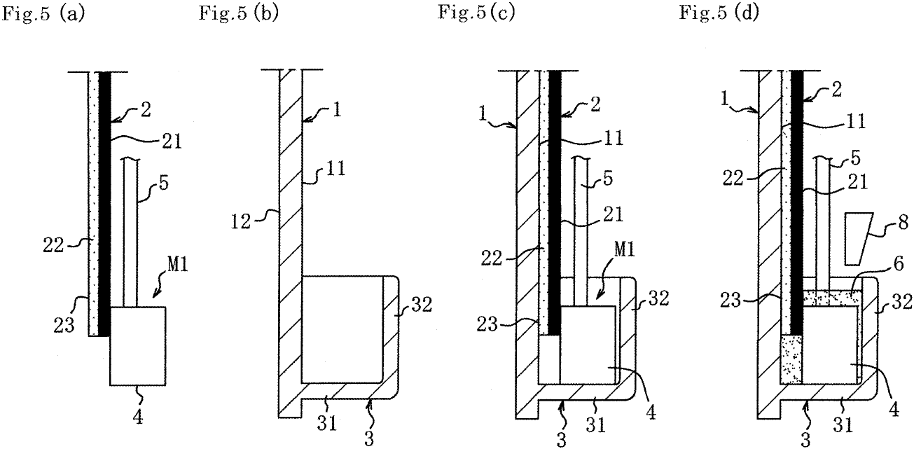

Next, a method for manufacturing the radome structure for vehicle-mounted radar devices of the present embodiment will be described (see FIG. 5). When manufacturing the radome structure for vehicle-mounted radar devices of the present embodiment, as shown in FIG. 5(a), an intermediate structure M1 composed of the planar heating element 2, the power supply line 5 to the planar heating element 2, and the connecting body 4 for electrically connecting the electrode of the planar heating element 2 and the terminal of the power supply line 5 is used. In the intermediate structure M1, the heater wire 21 of the planar heating element 2 is electrically connected to the connecting body 4 by exposing both electrodes from the insulating film 22 at a position close to the connecting body 4. The power supply line 5 for supplying electric power to the heater wire 21 is electrically connected to the connecting body 4 by exposing the terminal from the insulating coating at a position close to the connecting body 4. Further, the heater wire 21 of the intermediate structure M1 is wired in a predetermined manner such as a meandering manner while being covered with the insulating film 22.

Then, using the substrate 1 provided with the local recess 3 on the back surface 11 side (see FIG. 5b), the connecting body 4 for electrically connecting the electrode of the planar heating element 2 laminated and fixed onto the back surface 11 of the substrate 1 and the power supply line 5 to the planar heating element 2 is accommodated in the local recess 3 on the back surface 11 side of the substrate 1. In the manufacturing process of the present embodiment, the planar heating element 2 of the intermediate structure M1 is laminated and fixed onto the back surface 11 of the substrate 1, and the connecting body 4 of the intermediate structure M1 is accommodated in the local recess 3 on the back surface 11 side of the substrate 1. In this example, the fixing of the planar heating element 2 to the back surface 11 of the substrate 1 is performed by fixing the insulating film 22 in which the heater wire 21 of the planar heating element 2 is fixed to the back surface side to the back surface 11. In addition, accommodation of the connecting body 4 in the recess 3 is performed by inserting the connecting body 4 from the open side of the recess 3 (see FIG. 5(c)). In the present embodiment, a notch 221 is formed in the insulating film 22 of the planar heating element 2 so as to straddle the recess 3, and a tip of an extension portion 23 which is formed by the heater wire 21 and the insulating film 22 closer to the recess 3 than the notch 221 and extends to the connecting body 4 is accommodated in the local recess 3 together with the connecting body 4 (see FIGS. 1, 2 and 5).

Next, the substrate 1 is conveyed with the open side of the recess 3 accommodating the connecting body 4 facing upward, and a melted thermoplastic insulating resin 6 is injected into the recess 3 accommodating the connecting body 4 from the upper side by an injection nozzle 8 while being conveyed in this state. The recess 3 is filled with the insulating resin 6 to embed and seal the connecting body 4 (see FIG. 5(d)). The resin injected and filled into the recess 3 may be an insulating resin other than the thermoplastic insulating resin 6, and, for example, may be a one-liquid moisture-curing resin or a two-liquid reaction-curing resin. After that, the substrate 1 with the insulating resin 6 filled in the recess 3 is conveyed, and the insulating resin 6 with the connecting body 4 embedded therein is cured in the middle of the conveyance or in the stationary state after the conveyance. In this way, the radome structure for vehicle-mounted radar devices according to the present embodiment is obtained.

According to the radome structure for vehicle-mounted radar devices of the present embodiment, it is possible to eliminate the need to use a waterproof connector with a waterproof structure for the heater wire-side connector and apply a waterproof treatment using another waterproof member to the coupling point between the heater wire-side connector and the vehicle-side connector. That is, it is possible to simplify a connection structure and a waterproof structure of a connecting portion for electrically connecting the heater wire 21 and the power supply line 5 of the radome, and reduce the manufacturing cost of the radome structure having a snow melting function.

Further, when manufacturing the radome structure for vehicle-mounted radar devices of the present embodiment, the substrate 1 is conveyed with the open side of the local recess 3 accommodating the connecting body 4 facing upward, and the insulating resin 6 is injected and filled into the recess 3 that opens upward. Thus, leakage of the insulating resin 6 in a fluid state can be prevented even when no special liquid leakage prevention treatment is performed. Furthermore, even after the insulating resin 6 in a fluid state is injected into the local recess 3, since the recess 3 is kept open upward, it is possible to prevent leakage of the insulating resin 6 in a fluid state and cure the insulating resin 6 with the lapse of time due to conveyance. Therefore, a radome structure having both a waterproof structure and a snow-melting structure can be manufactured very efficiently, and the manufacturing cost of the radome structure can be further reduced because no special liquid leakage prevention treatment is required.

Further, in the manufacturing process, the connecting body 4 of the intermediate structure M1 is accommodated in the local recess 3 of the substrate 1 using the intermediate structure M1 composed of the planar heating element 2, the power supply line 5, and the connecting body 4 thereof. Thus, it is possible to eliminate the need for the work of electrically connecting the planar heating element 2 and the connecting body 4 in the narrow space in the local recess 3 and the work of electrically connecting the power supply line 5 and the connecting body 4, simplifying the manufacturing process and further improving the efficiency. In addition, when the connection work is performed within the local recess 3 using solder or the like for the electrical connection between the planar heating element 2 and the connecting body 4, or the electrical connection between the power supply line 5 and the connecting body 4, there is a possibility that a synthetic resin forming the substrate 1 or a synthetic resin forming the local recesses 3 may melt. However, since the connecting body 4 of the intermediate structure M1 is accommodated in the recess 3 of the substrate 1, it is possible to prevent the deformation and defects of the shape due to melting of the synthetic resin.

### Scope of Inclusion of Invention Disclosed in Present Specification

The invention disclosed in the present specification includes each invention and each embodiment, and, within an applicable range, an invention specified by changing a partial configuration thereof to another configuration disclosed in the present specification, an invention specified by adding another configuration disclosed in the present specification to the configuration thereof, and an invention obtained by reducing, specifying and highly conceptualizing the partial configuration thereof as long as a partial effect is acquired. The invention disclosed in the present specification includes the following modified embodiments and postscripts.

The radome structure for vehicle-mounted radar devices of the present invention can be applied to appropriate vehicle-mounted parts mounted on a vehicle, in addition to the preferred examples of the emblem such as the front grille or the bumper described above. Further, the radome for vehicle-mounted radar devices of the present invention is preferably manufactured by the manufacturing process example of the above-described embodiment, but a radome manufactured by a manufacturing process other than this, such as one manufactured without using the intermediate structure M1 is also included in the radome for vehicle-mounted radar devices of the present invention.

Further, an electromagnetic wave permeable waterproof layer made of materials such as, for example, epoxy-based polyurethane waterproof materials, polyester-based waterproof materials, silicone-based waterproof materials, acrylic-based waterproof materials, methacrylic-based waterproof materials, or titania-based waterproof materials may be preferably laminated and fixed to the outermost surface of the radome of the radome structure for vehicle-mounted radar devices of the present invention, such as the outer surface of the transparent substrate 72 in the above embodiment to improve waterproofness. Alternatively, an electromagnetic wave permeable water-repellent layer made of materials such as, for example, acrylic water-repellent materials or silicon-based water repellent materials may be laminated or a water-repellent nanostructure may be fixed so as to be imparted to the surface to enhance water repellency. Alternatively, a waterproof layer and a water-repellent layer may be laminated in order and fixed to the outer surface of a resin body to enhance both water repellency and waterproofness.

In addition, an electromagnetic wave permeable hard coat layer made of materials such as, for example, organic hard coat materials such as melamine-based hard coat materials, urethane-based hard coat materials, or acrylic-based hard coat materials, silicone-based hard coat materials, or inorganic hard coat materials may be preferably laminated and fixed to the outermost surface of the radome of the radome structure for vehicle-mounted radar devices of the present invention, such as the outer surface of the transparent substrate 72 in the above embodiment to protect the outer surface to enhance the strength and durability of the radome.

Further, an electromagnetic wave permeable hydrophilic layer made of materials such as organic hydrophilic materials, silane-based hydrophilic materials, and titania-based hydrophilic materials may be preferably laminated and fixed to the outermost surface of the radome of the radome structure for vehicle-mounted radar devices of the present invention, such as the outer surface of the transparent substrate 72 in the above embodiment. Alternatively, a hydrophilic nanostructure may be imparted to the surface. Thus, melted snow is retained on the surface of the radome as water, and adhering of another snow is prevented using the latent heat of water.

In the above-described embodiment, the local recess 3 is provided by a member protruding from the back surface 11 of the substrate 1 toward the side opposite to the viewing side. For example, the planar heating element 2 may be preferably laminated and fixed onto the back surface 11 on the side opposite to the viewing side of the substrate 1 corresponding to the radome substrate, and the local recess 3 may be provided by a member protruding sideways from the side end surface 14 of the substrate 1. Also, the connecting body 4 may be accommodated in the recess 3, and the insulating resin 6 may be filled into the recess 3 so as to embed and seal the accommodated connecting body 4.

In addition, in the present invention, the configuration in which the electrode of the planar heating element and the connecting body are fixed and electrically connected, and the configuration in which the power supply line to the planar heating element and the connecting body are fixed and electrically connected can use an appropriate fixing structure that allows electrical connection. For example, a fixing structure by soldering, a fixing structure by caulking, a fixing structure by crimping, a fixing structure by bonding with a conductive adhesive, or the like may be used.

In addition, the local recess 3 of the present invention is not limited to a configuration in which a single recess is provided in the radome substrate, and a plurality of local recesses may be preferably provided. For example, two local recesses may be provided in one radome substrate. One connecting body for electrically connecting one electrode of the planar heating element or the heater wire and one power supply line to the planar heating element may be accommodated in one recess. One connecting body accommodated in one recess, including the connecting portion, may be embedded in the insulating resin. The other connecting body for electrically connecting the other electrode of the planar heating element or the heater wire and the other power supply line to the planar heating element may be accommodated in the other recess. The other connecting body accommodated in the other recess, including the connecting portion, may be preferably embedded in the insulating resin.

### INDUSTRIAL APPLICABILITY

The present invention can be used as a radome structure for vehicle-mounted radar devices.

Reference Signs List

| | |
|---|---|
| 1 | Substrate |
| 11 | Back surface |
| 12 | Front surface |
| 13 | Protrusion |
| 14 | Side end surface |
| 2 | Planar heating element |
| 21 | Heater wire |
| 22 | Insulating film |
| 221 | Notch |
| 23 | Extension portion |
| 3 | Recess |
| 31 | Bottom portion |
| 32 | Peripheral wall |
| 4 | Connecting body |
| 5 | Power supply line |
| 6 | Insulating resin |
| 71 | Decorative layer |
| 711 | Electromagnetic wave permeable metal portion |
| 712 | Colored portion |
| 72 | Transparent substrate |
| 721 | Recess |
| 73 | Rear substrate |
| 8 | Injection nozzle |
| 10 | Radome |
| 100 | Vehicle-mounted radar device |
| R | Electromagnetic wave irradiation region |
| M1 | Intermediate structure |

1-5. (canceled)

6. A radome structure for vehicle-mounted radar devices, wherein
a planar heating element is laminated and fixed onto a radome substrate,
a local recess is provided by a member protruding from the radome substrate;
a connecting body for electrically connecting an electrode of the planar heating element and a power supply line to the planar heating element is accommodated in the recess, and
the recess is filled with an insulating resin so as to embed and seal the connecting body.

7. The radome structure for vehicle-mounted radar devices according to claim 6, wherein
the planar heating element is laminated and fixed onto a back surface on an opposite side of a viewing side of the radome substrate, and
the member of the recess is provided so as to protrude from the back surface of the radome substrate toward the opposite side of the viewing side, or is provided so as to protrude sideways from a side end surface of the radome substrate.

8. The radome structure for vehicle-mounted radar devices according to claim 6, wherein
the recess is arranged at a position outside an electromagnetic wave irradiation region of the radome substrate irradiated by a vehicle-mounted radar device.

9. The radome structure for vehicle-mounted radar devices according to claim 7, wherein
the recess is arranged at a position outside an electromagnetic wave irradiation region of the radome substrate irradiated by a vehicle-mounted radar device.

10. A method for manufacturing the radome structure for vehicle-mounted radar devices according to claim 6, comprising:
a first step of accommodating a connecting body for electrically connecting an electrode of a planar heating element laminated and fixed onto a radome substrate and a power supply line to the planar heating element in a local recess provided by a member protruding from the radome substrate; and
a second step of conveying the radome substrate with an open side of the recess accommodating the connecting body facing upward and filling the recess with an insulating resin while being conveyed in this state to embed and seal the connecting body.

11. A method for manufacturing the radome structure for vehicle-mounted radar devices according to claim 7, comprising:
a first step of accommodating a connecting body for electrically connecting an electrode of a planar heating element laminated and fixed onto a radome substrate and a power supply line to the planar heating element in a local recess provided by a member protruding from the radome substrate; and
a second step of conveying the radome substrate with an open side of the recess accommodating the connecting body facing upward and filling the recess with an insulating resin while being conveyed in this state to embed and seal the connecting body.

12. A method for manufacturing the radome structure for vehicle-mounted radar devices according to claim 8, comprising:
a first step of accommodating a connecting body for electrically connecting an electrode of a planar heating element laminated and fixed onto a radome substrate and a power supply line to the planar heating element in a local recess provided by a member protruding from the radome substrate; and
a second step of conveying the radome substrate with an open side of the recess accommodating the connecting body facing upward and filling the recess with an insulating resin while being conveyed in this state to embed and seal the connecting body.

13. A method for manufacturing the radome structure for vehicle-mounted radar devices according to claim 9, comprising:
a first step of accommodating a connecting body for electrically connecting an electrode of a planar heating element laminated and fixed onto a radome substrate and a power supply line to the planar heating element in a local recess provided by a member protruding from the radome substrate; and
a second step of conveying the radome substrate with an open side of the recess accommodating the connecting body facing upward and filling the recess with an insulating resin while being conveyed in this state to embed and seal the connecting body.

14. The method for manufacturing the radome structure for vehicle-mounted radar devices according to claim 10, wherein
the first step involves using an intermediate structure including a planar heating element, a power supply line to the planar heating element, and a connecting body for electrically connecting an electrode of the planar heating element and the power supply line to laminate and fix the planar heating element of the intermediate structure onto a radome substrate and accommodating the connecting body of the intermediate structure in the local recess provided by a member protruding from the radome substrate.

15. The method for manufacturing the radome structure for vehicle-mounted radar devices according to claim 11, wherein
the first step involves using an intermediate structure including a planar heating element, a power supply line to the planar heating element, and a connecting body for electrically connecting an electrode of the planar heating element and the power supply line to laminate and fix the planar heating element of the intermediate structure onto a radome substrate and accommodating the connecting body of the intermediate structure in the local recess provided by a member protruding from the radome substrate.

16. The method for manufacturing the radome structure for vehicle-mounted radar devices according to claim 12, wherein
the first step involves using an intermediate structure including a planar heating element, a power supply line to the planar heating element, and a connecting body for electrically connecting an electrode of the planar heating element and the power supply line to laminate and fix the planar heating element of the intermediate structure onto a radome substrate and accommodating the connecting body of the intermediate structure in the local recess provided by a member protruding from the radome substrate.

17. The method for manufacturing the radome structure for vehicle-mounted radar devices according to claim 13, wherein
the first step involves using an intermediate structure including a planar heating element, a power supply line to the planar heating element, and a connecting body for electrically connecting an electrode of the planar heating element and the power supply line to laminate and fix the planar heating element of the intermediate structure onto a radome substrate and accommodating the connecting body of the intermediate structure in the local recess provided by a member protruding from the radome substrate.
